(19) United States
(12) Patent Application Publication
(10) Pub. No.: US 2022/0414478 A1
(43) Pub. Date: Dec. 29, 2022

(54) DYNAMIC CONTAINER CREATION BASED ON IDENTIFIED CONTEXTUAL NEED

(71) Applicant: International Business Machines Corporation, Armonk, NY (US)

(72) Inventors: Venkata Vara Prasad Karri, Visakhapatnam (IN); Sarbajit K. Rakshit, Kolkata (IN); Pavan K Manda, Visakhapatnam (IN); Sowjanya Rao, Hyderabad (IN)

(21) Appl. No.: 17/357,082

(22) Filed: Jun. 24, 2021

(51) Int. Cl. G06N 5/02; G06F 21/62

(52) U.S. Cl. CPC G06N 5/02; G06F 21/6218

(57) ABSTRACT

Technology for implementing methods that include the following operations: (i) receiving a container instantiation data set that includes the data needed to instantiate at least a first type of container; (ii) receiving a computing environment context data set including information relevant to computing operations currently being performed in a computer environment, with the computer environment context data set including information indicative of a first internal factor and/or a first external factor; (iii) applying an artificial intelligence algorithm to determine a predicted future status of the computing environment based, at least in part, upon the computer environment context data set; (iv) determining, by machine logic and based, at least in part upon the predicted future status, that the computing environment is likely to operate better if a new container of the first type is instantiated; and (v) automatically instantiating a first container.

### BACKGROUND

The present invention relates generally to the field of “containers,” (see definition, below) and more particularly to creating new containers.

The Wikipedia entry for “OS-level virtualization” (as of May 18, 2021) states as follows: “OS-level virtualization is an operating system paradigm in which the kernel allows the existence of multiple isolated user space instances. Such instances, called containers (LXC, Solaris containers, Docker), Zones (Solaris containers), virtual private servers (OpenVZ), partitions, virtual environments (VEs), virtual kernels (DragonFly BSD), or jails (FreeBSD jail or chroot jail), may look like real computers from the point of view of programs running in them. A computer program running on an ordinary operating system can see all resources (connected devices, files and folders, network shares, CPU power, quantifiable hardware capabilities) of that computer. However, programs running inside of a container can only see the container's contents and devices assigned to the container . . . . Several containers can be created on each operating system, to each of which a subset of the computer's resources is allocated. Each container may contain any number of computer programs. These programs may run concurrently or separately, and may even interact with one another. Containerization has similarities to application virtualization: In the latter, only one computer program is placed in an isolated container and the isolation applies to file system only.” (footnote(s) omitted)

Published US patent application 2018/0373551 (“Christensen”) states, in part as follows: “[U]sing dynamic templates to create application containers may include (i) identifying an application that is to be deployed in a container, (ii) creating a dynamic template that comprises at least one variable parameter and that defines at least a portion of an operating environment of the container, (iii) generating a value of the variable parameter during deployment of the application, (iv) processing the dynamic template to create a configuration file that comprises the value of the variable parameter, and (v) triggering a container initialization system to create, based on the configuration file, the container such that the container isolates a user space of the application from other software on a host system while sharing a kernel space with the other software. Various other methods, systems, and computer-readable media are also disclosed.”

### SUMMARY

According to an aspect of the present invention, there is a method, computer program product and/or system that performs the following operations (not necessarily in the following order): (i) receiving a container instantiation data set that includes the data needed to instantiate at least a first type of container; (ii) receiving a computing environment context data set including information relevant to computing operations currently being performed in a computer environment, with the computer environment context data set including information indicative of a first internal factor and/or a first external factor; (iii) applying an artificial intelligence algorithm to determine a predicted future status of the computing environment based, at least in part, upon the computer environment context data set; (iv) determining, by machine logic and based, at least in part upon the predicted future status, that the computing environment is likely to operate better if a new container of the first type is instantiated; and (v) automatically instantiating, in the computing environment and based, at least in part, upon the container instantiation data set, a first container of the first type.

According to an aspect of the present invention, there is a method, computer program product and/or system that performs the following operations (not necessarily in the following order): (i) receiving a container instantiation data set that includes the data needed to instantiate at least a first type of container; (ii) receiving a computing environment context data set including information relevant to computing operations currently being performed in a computer environment, with the computer environment context data set including information indicative of at least first external factor; (iii) applying an artificial intelligence algorithm to determine a predicted future status of the computing environment based, at least in part, upon the computer environment context data set; (iv) determining, by machine logic and based, at least in part upon the predicted future status, that the computing environment is likely to operate better if a new container of the first type is instantiated; and (v) automatically instantiating, in the computing environment and based, at least in part, upon the container instantiation data set, a first container of the first type.

According to an aspect of the present invention, there is a method, computer program product and/or system that performs the following operations (not necessarily in the following order): (i) receiving a container instantiation data set that includes the data needed to instantiate at least a first type of container; (ii) receiving a computing environment context data set including information relevant to computing operations currently being performed in a computer environment, with the computer environment context data set including information indicative of at least a first internal factor and a first external factor; (iii) applying an artificial intelligence algorithm to determine a predicted future status of the computing environment based, at least in part, upon the computer environment context data set; (iv) determining, by machine logic and based, at least in part upon the predicted future status, that the computing environment is likely to operate better if a new container of the first type is instantiated; and (v) automatically instantiating, in the computing environment and based, at least in part, upon the container instantiation data set, a first container of the first type.

### BRIEF DESCRIPTION OF THE DRAWINGS

FIG. 1 is a block diagram view of a first embodiment of a system according to the present invention;

FIG. 2 is a flowchart showing a first embodiment method performed, at least in part, by the first embodiment system;

FIG. 3 is a block diagram showing a machine logic (for example, software) portion of the first embodiment system;

FIG. 4 is a screenshot view generated by the first embodiment system; and

FIG. 5 is a block diagram helpful in understanding various embodiments of the present invention.

### DETAILED DESCRIPTION

This Detailed Description section is divided into the following subsections: (i) The Hardware and Software Environment; (ii) Example Embodiment; (iii) Further Comments and/or Embodiments; and (iv) Definitions.

### I. The Hardware and Software Environment

The present invention may be a system, a method, and/or a computer program product at any possible technical detail level of integration. The computer program product may include a computer readable storage medium (or media) having computer readable program instructions thereon for causing a processor to carry out aspects of the present invention. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (for example, light pulses passing through a fiber-optic cable), or electrical signals transmitted through a wire.

A “storage device” is hereby defined to be anything made or adapted to store computer code in a manner so that the computer code can be accessed by a computer processor. A storage device typically includes a storage medium, which is the material in, or on, which the data of the computer code is stored. A single “storage device” may have: (i) multiple discrete portions that are spaced apart, or distributed (for example, a set of six solid state storage devices respectively located in six laptop computers that collectively store a single computer program); and/or (ii) may use multiple storage media (for example, a set of computer code that is partially stored in as magnetic domains in a computer's non-volatile storage and partially stored in a set of semiconductor switches in the computer's volatile memory). The term “storage medium” should be construed to cover situations where multiple different types of storage media are used.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

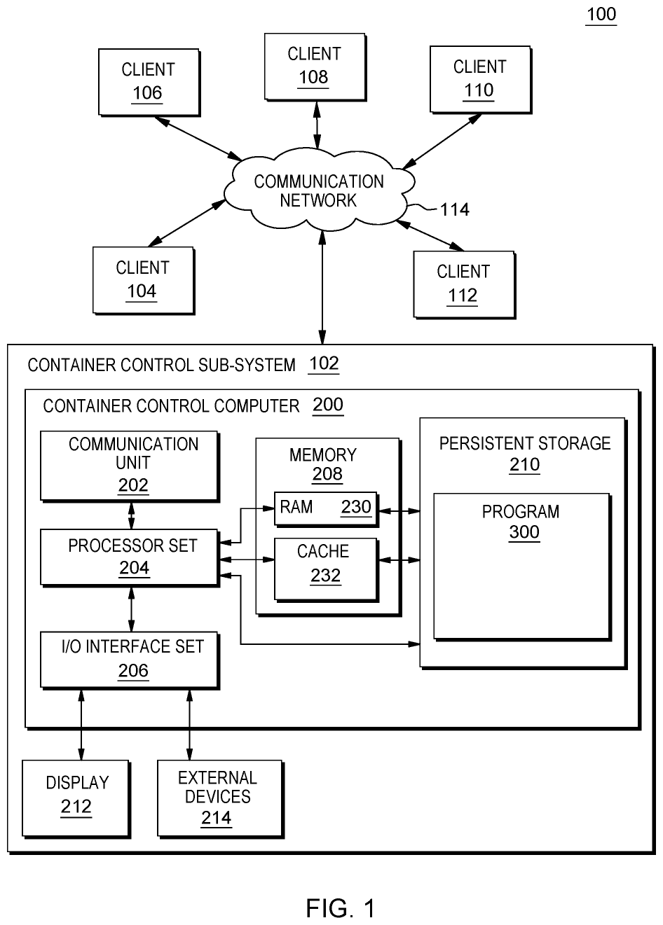

As shown in FIG. 1, networked computers system 100 is an embodiment of a hardware and software environment for use with various embodiments of the present invention. Networked computers system 100 includes: container control subsystem 102 (sometimes herein referred to, more simply, as subsystem 102); client subsystems 104, 106, 108, 110, 112; and communication network 114. Container control subsystem 102 includes: container control computer 200; communication unit 202; processor set 204; input/output (I/O) interface set 206; memory 208; persistent storage 210; display 212; external device(s) 214; random access memory (RAM) 230; cache 232; and program 300.

Subsystem 102 may be a laptop computer, tablet computer, netbook computer, personal computer (PC), a desktop computer, a personal digital assistant (PDA), a smart phone, or any other type of computer (see definition of “computer” in Definitions section, below). Program 300 is a collection of machine readable instructions and/or data that is used to create, manage and control certain software functions that will be discussed in detail, below, in the Example Embodiment subsection of this Detailed Description section.

Subsystem 102 is capable of communicating with other computer subsystems via communication network 114. Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client subsystems.

Subsystem 102 is shown as a block diagram with many double arrows. These double arrows (no separate reference numerals) represent a communications fabric, which provides communications between various components of subsystem 102. This communications fabric can be implemented with any architecture designed for passing data and/or control information between processors (such as microprocessors, communications and network processors, etc.), system memory, peripheral devices, and any other hardware components within a computer system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for subsystem 102; and/or (ii) devices external to subsystem 102 may be able to provide memory for subsystem 102. Both memory 208 and persistent storage 210: (i) store data in a manner that is less transient than a signal in transit; and (ii) store data on a tangible medium (such as magnetic or optical domains). In this embodiment, memory 208 is volatile storage, while persistent storage 210 provides nonvolatile storage. The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202 provides for communications with other data processing systems or devices external to subsystem 102. In these examples, communications unit 202 includes one or more network interface cards. Communications unit 202 may provide communications through the use of either or both physical and wireless communications links. Any software modules discussed herein may be downloaded to a persistent storage device (such as persistent storage 210) through a communications unit (such as communications unit 202).

I/O interface set 206 allows for input and output of data with other devices that may be connected locally in data communication with container control computer 200. For example, I/O interface set 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 300, can be stored on such portable computer-readable storage media. I/O interface set 206 also connects in data communication with display 212. Display 212 is a display device that provides a mechanism to display data to a user and may be, for example, a computer monitor or a smart phone display screen.

In this embodiment, program 300 is stored in persistent storage 210 for access and/or execution by one or more computer processors of processor set 204, usually through one or more memories of memory 208. It will be understood by those of skill in the art that program 300 may be stored in a more highly distributed manner during its run time and/or when it is not running. Program 300 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### II. Example Embodiment

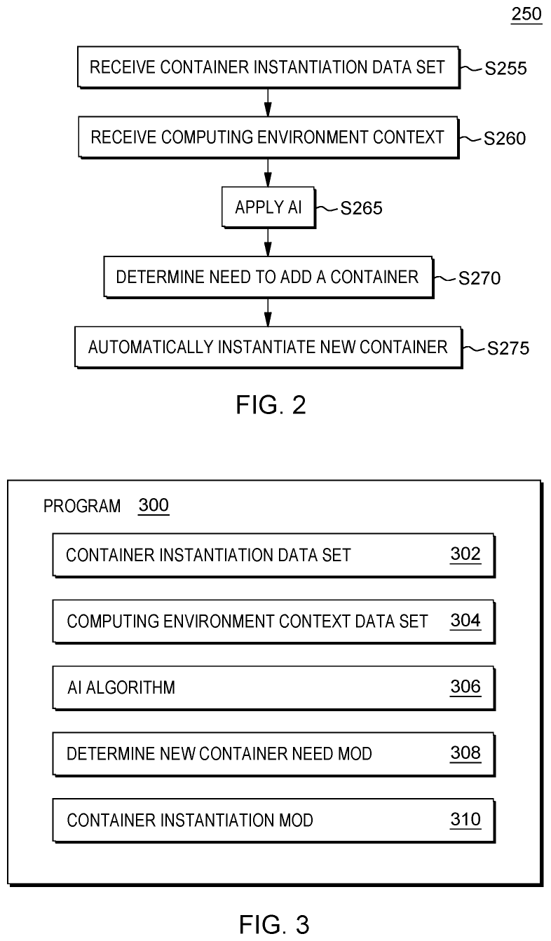

As shown in FIG. 1, networked computers system 100 is an environment in which an example method according to the present invention can be performed. As shown in FIG. 2, flowchart 250 shows an example method according to the present invention. As shown in FIG. 3, program 300 performs or controls performance of at least some of the method operations of flowchart 250. This method and associated software will now be discussed, over the course of the following paragraphs, with extensive reference to the blocks of FIGS. 1, 2 and 3.

Processing begins at operation S255, where container instantiation data set 302 is received by container control computer 200. Container instantiation data set 302 includes the data needed to instantiate at least a first type of container. In this example, the container instantiation data set is received from client sub-system 104 (which is a container repository) and through communication network 114. In this example, container instantiation data set is largely made up of images of Docker containers, from which Docker containers can be instantiated. In this example, each image (or, “image file”) in data set 302 is a different container type, suited and/or optimized for: performing a different types of computing tasks/jobs; performing computing at a different scale; performing computing based on different types of underlying middleware and/or hardware platforms; and/or operating within different container orchestration environments.

Processing proceeds to operation S260, where computing environment context data set 304 is received by container control computer 200. Environment control context data set 304 includes information relevant to computing operations currently being performed in a computer environment. In this example, the computer environment that is being monitored and logged for control by container control computer 200, is made up of client sub-systems 106, 108, 110, 112 and the portion of network 114 that interconnects these computers in data communication with each other. Computer environment context data set 304 includes information indicative of at least a first internal factor. The difference between “internal factors” and “external factors” will be made clear in the following sub-section of this Detailed Description.

Processing proceeds to operation S265, where artificial intelligence algorithm 306 is applied to determine a predicted future status of the computing environment based, at least in part, on computer environment context data set 304.

Processing proceeds to operation S270, where determine new container need module (“mod”) 308 determines, by its machine logic and based, at least in part upon the predicted future status, that the computing environment is likely to operate better if a new container of the first type is instantiated.

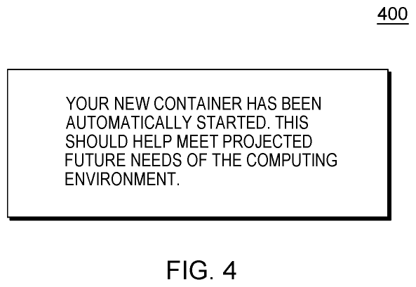

Processing proceeds to operation S275, where container instantiation mod 310 automatically instantiates, in the computing environment and based, at least in part, upon the container instantiation data set, a first container of the first type. (See FIG. 4, screenshot 400)

Some embodiments of the present invention may include one, or more, of the following operations and/or feature: (i) the container instantiation data set includes a container image file; (ii) applying the artificial intelligence algorithm predicts a codebase from a set of repository(ies); (iii) automatically identifies a set of unit test(s) to be performed; (iv) identifies the appropriate codes and security rules from the set of repository(ies); (v) creates a first microservice; (vi) automatically deploys the first microservice; (vii) using historical learning to identify the pattern of change indicated by the computer environment contextual data set; (viii) applies the artificial intelligence algorithm to predict system requirements; and/or (ix) predicting: functional requirements, non-functional requirements, predicting security requirements, predicting a number of users to use, and/or predicting a workflow sequence.

### III. Further Comments and/or Embodiments

Some embodiments of the present invention recognize the following facts, potential problems and/or potential areas for improvement with respect to the current state of the art: (i) in different contextual situations, different activities are to be performed by the users; (ii) the activities can be short term or long term; (iii) the activities can be for single or multiple users; and/or (iv) in any code repository, such as commercially available code hosting platforms, there can be different types of reusable code where the code can be reused to create different applications.

Some embodiments of the present invention recognize the following facts, potential problems and/or potential areas for improvement with respect to the current state of the art: (i) for different contextual situations, there is a need to create different applications and allow the same to be used by various users; and/or (ii) what is needed is a dynamic container creation and deployment, in different systems, so that the users can use the same properly, on a demand basis.

Some embodiments of the present invention may include one, or more, of the following operations, features, characteristics and/or advantages: (i) includes an AI (artificial intelligence) enabled system which considers various sources of information (for example, external or internal influencing factors); (ii) predicts changes in a contextual situation which can lead to activities being performed differently; (iii) uses AI to predict the codebase from the multifarious repositories; (iv) automatically identifies the unit tests to be performed; (v) identifies the appropriate codes and security rules from a centralized code repository; and/or (vi) creates a microservice for auto-deployment.

Some embodiments of the present invention may include one, or more, of the following operations, features, characteristics and/or advantages: (i) predicts any change in a contextual situation; (ii) uses historical learning to identify the pattern of change in the contextual situation; (iii) determines if the creation of a new container brings additional advantages; (iv) uses AI to predict system requirements; (v) helps in automatically creating test cases; (vi) checks the security related aspects; and/or (vii) considers the storage requirements.

Some embodiments of the present invention may include one, or more, of the following operations, features, characteristics and/or advantages: (i) predicts any change in a contextual situation where different activities are to be performed; and/or (ii) based on a predicted change in the contextual situation, the system will predict: (a) functional requirements, (b) non-functional requirements, (c) security requirements, (d) the number of users to use, (e) workflow sequence, and/or (f) user detail, role, etc., where the application for the change in contextual needs can be created.

Some embodiments of the present invention may include one, or more, of the following operations, features, characteristics and/or advantages: (i) based on the identified predicted requirements of the predicted change in contextual situation, the system will identify: (a) the appropriate code, (b) the security rules from a centralized code repository, and/or (c) create a microservice for auto-deployment; (ii) uses AI to predict the codebase, from multifarious repositories (such as commercially available code hosting platforms) to automatically generate a microservice, based on the contextual need identified for the dynamic or ad-hoc requirement accommodation, by performing a real time prediction on the codebase; and/or (iii) using historical learning, the system will identify the pattern of change in the contextual situation, where if the creation of a microservice will bring additional advantages, create the new microservice so activities can be performed in a different manner or different activities can be performed.

Some embodiments of the present invention may include one, or more, of the following operations, features, characteristics and/or advantages: (i) creates a dynamic microservice based on contextual needs that will create a dynamic container; and/or (ii) based on predictions with the identified code base and unit test cases, the microservice will create a dynamic container with the automatically generated microservice.

Some embodiments of the present invention may include one, or more, of the following operations, features, characteristics and/or advantages: (i) considers various sources of information, such as external and internal influencing factors, then accordingly predicts any change in the contextual situation; (ii) based on the identified predicted requirements in the contextual situation, the system will identify the appropriate code and security rules from the centralized code repository and accordingly create a container for auto-deployment; (iii) an AI enabled engine can also predict the threshold limits of load that can hit the application per identified context and predicted variables/parameters; (iv) the system checks the security related aspects, such as but not limited to: (a) encryption, (b) end point manager settings, and/or (c) certificates to be installed or removed, etc.; and/or (v) the system further checks for effective network traffic management and automatically creates an open standard file format/data interchange format for orchestrated deployments.

Some embodiments of the present invention may include one, or more, of the following operations, features, characteristics and/or advantages: (i) includes an AI enabled system which predicts any change in the contextual situation using various sources of information such as external and internal influencing factors; (ii) predicts the codebase from various source controls and from various repositories; and/or (iii) identifies the corresponding unit test cases to perform.

Some embodiments of the present invention may include one, or more, of the following operations, features, characteristics and/or advantages: (i) includes changes in a contextual situation that will be predicted; (ii) will predict the appropriate functional and non-functional requirements related to: (a) change, (b) security requirements, and/or (c) the number of users, etc.; and/or (ii) will dynamically create appropriate containers considering various reusable code from the repository and will deploy the same.

Some embodiments of the present invention may include one, or more, of the following operations, features, characteristics and/or advantages: (i) predicts the system requirements (which are currently free and available, but are not limited to open ports, gateways, or any other environmental specific resources) to create a dynamic docker file for the dynamic contextual need; (ii) based on the predictions performed by the AI engine, the system will automatically identify the unit tests to be performed (such as mapping historical data); and/or (iii) helps in automatically creating test cases.

Some embodiments of the present invention may include one, or more, of the following operations, features, characteristics and/or advantages: (i) the system has the capability to consider the storage requirements and storage type (single or distributed) of the container (in a running state); (ii) the system has the capability to be run in a state that will automatically allocate the storage based on, but not limited to: (a) historical analysis of data by application type and load, and/or (b) the user satisfaction scorecard derived from users experiences for the given context; (iii) has augmented intelligence that will classify and cluster the tasks to the respective user personas to view their assigned tasks and make corrections and/or approve/reject decisions (with comments) for improved efficiency; (iv) considers the users comments and validates them against the context and generated output files; and/or (v) re-validates and repeats the process for more accurate results, and further validation/confirmation from the user.

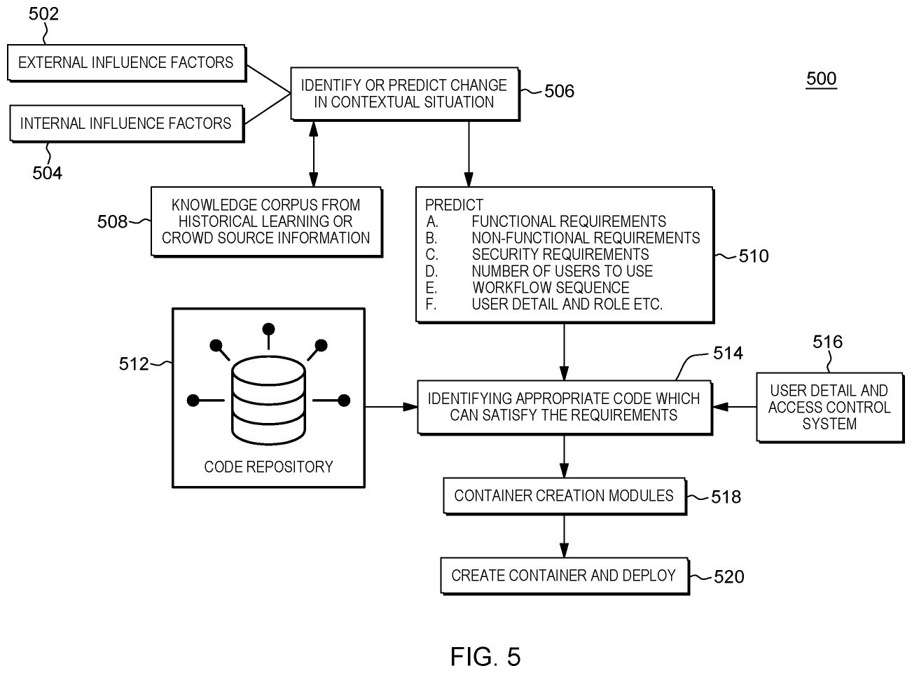

As shown in FIG. 5, diagram 500 includes: external influence factors block 502; internal influence factors block 504; identify or predict change in contextual situation block 506; knowledge corpus from historical learning or crowd source information block 508; predict a. functional requirements, b. non-functional requirements, c. security requirements, d. number of users to use, e. workflow sequence, f. user detail and role etc. block 510; code repository block 512; identifying appropriate code which can satisfy the requirements block 514; user detail and access control system block 516; container creation modules block 518; and create container and deploy block 520.

According to embodiments of the present invention, FIG. 5, diagram 500 talks about a change in a contextual situation that is predicted (such as when a cyber-attack scenario is detected via an external news source). Accordingly, based on the change in the contextual situation, the system will: (a) identify new requirements, and (b) create the appropriate containers so that the activities can be performed during the change in the contextual situation.

According to additional embodiments of the present invention, the following operations will be performed in the following eight (8) paragraphs with reference to FIG. 5, diagram 500.

In any codebase, each code element will be identified uniquely, and each code element will have identifying properties. The system will identify the functional and non-functional parameters of the code (510). The system will also identify the roles and responsibilities of the people of the organization (510).

Different code elements will have a mapping with functional requirements and will also be have a version installed (510). The system will also have a data collection module, where the data collection module will identify various internal influencing factors (504) and external influencing factors (502). The external influencing factors (502) can be identified as to which are influencing the business, but is not related to the organization.

As part of external influencing factors (502), the system will identify items such as customer information, news, research papers, change in government policy, etc. (506). Part of internal influencing factors can be mergers and acquisitions (M&A), change in human resources (HR) policy, etc. The system can receive the external influencing factors (502) and internal influencing factors (504) from various predefined sources.

Based on external influencing factors (502) or internal influencing factors (504), the system will perform the scenarios which can influence the business. The influence on the business can be changes in the activity pattern, performing additional activities, cancelling some activities, etc. In addition, based on the historical pattern of interaction with various business applications, the system will identify how the application is performed, the types of activities there are, etc.

The system will compare if the identified change in the contextual situation can change the working pattern. In this case, the system can use an AI enabled system. The AI enabled system can use a prebuilt knowledge corpus (508) about the activities for different contextual situations, and the knowledge corpus (508) can be built from a crowd sourced experience, etc.

Once the change in the contextual situation is identified, the system will identify how the activity is to be performed from the knowledge corpus (508). Using historical learning and the change in the contextual situation, the system will identify the requirements, as per the users performing the same activities in a different manner, or performing different activities (516).

The system will also use the code repository (512) to identify which code element is appropriate for the new mode of activity. If any required code element is not found in the code repository (512), then the system will notify the developer to develop the code (514).

The system will then identify the appropriate code from the code repository (512), and will identify the workflow sequence (510). The system will identify the required security needed (510) and will create the docker file (518). The system will then create the container with the new contextual situation and the appropriate security will be assigned to the user(s) (520).

Some embodiments of the present invention may include one, or more, of the following operations, features, characteristics and/or advantages: (i) uses an AI enabled system to consider various sources of information (for example, external or internal influencing factors) and accordingly predicts any change in the contextual situation where users need to perform the activities differently or if different activities need to be performed; (ii) microservices are created for the container; and/or (iii) analyzes the contextual situation and determines what functionalities are to be considered and which will be creating a new container/microservice.

### IV. Definitions

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

Including/include/includes: unless otherwise explicitly noted, means “including but not necessarily limited to.”

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

What is claimed is:

1. A computer-implemented method (CIM) comprising:
receiving a container instantiation data set that includes the data needed to instantiate at least a first type of container;
receiving a computing environment context data set including information relevant to computing operations currently being performed in a computer environment, with the computer environment context data set including information indicative of at least first internal factor;
applying an artificial intelligence algorithm to determine a predicted future status of the computing environment based, at least in part, upon the computer environment context data set;
determining, by machine logic and based, at least in part upon the predicted future status, that the computing environment is likely to operate better if a new container of the first type is instantiated; and
automatically instantiating, in the computing environment and based, at least in part, upon the container instantiation data set, a first container of the first type.

2. The CIM of claim 1 wherein the container instantiation data set includes a container image file.

3. The CIM of claim 1 further comprising:
applying the artificial intelligence algorithm predict a codebase from a set of repository(ies);
automatically identifying a set of unit test(s) to be performed;
identifying the appropriate codes and security rules from the set of repository(ies); and/or
creating a first microservice; and
automatically deploying the first microservice.

4. The CIM of claim 1 wherein the application of the artificial intelligence algorithm to determine a predicted future status includes the following sub-operation(s):
using historical learning to identify the pattern of change indicated by the computer environment contextual data set.

5. The CIM of claim 1 wherein the application of the artificial intelligence algorithm to determine a predicted future status includes the following sub-operation(s):
applying the artificial intelligence algorithm to predict system requirements.

6. The CIM of claim 1 wherein the determination that the computing environment is likely to operate better if a new container of the first type is instantiated includes the following sub-operation(s):
predicting functional requirements;
predicting non-functional requirements;
predicting security requirements;
predicting a number of users to use; and
predicting a workflow sequence.

7. A computer-implemented method (CIM) comprising:
receiving a container instantiation data set that includes the data needed to instantiate at least a first type of container;
receiving a computing environment context data set including information relevant to computing operations currently being performed in a computer environment, with the computer environment context data set including information indicative of at least first external factor;
applying an artificial intelligence algorithm to determine a predicted future status of the computing environment based, at least in part, upon the computer environment context data set;
determining, by machine logic and based, at least in part upon the predicted future status, that the computing environment is likely to operate better if a new container of the first type is instantiated; and
automatically instantiating, in the computing environment and based, at least in part, upon the container instantiation data set, a first container of the first type.

8. The CIM of claim 7 wherein the container instantiation data set includes a container image file.

9. The CIM of claim 7 further comprising:
applying the artificial intelligence algorithm predict a codebase from a set of repository(ies);
automatically identifying a set of unit test(s) to be performed;
identifying the appropriate codes and security rules from the set of repository(ies); and/or
creating a first microservice; and
automatically deploying the first microservice.

10. The CIM of claim 7 wherein the application of the artificial intelligence algorithm to determine a predicted future status includes the following sub-operation(s):
using historical learning to identify the pattern of change indicated by the computer environment contextual data set.

11. The CIM of claim 7 wherein the application of the artificial intelligence algorithm to determine a predicted future status includes the following sub-operation(s):
applying the artificial intelligence algorithm to predict system requirements.

12. The CIM of claim 7 wherein the determination that the computing environment is likely to operate better if a new container of the first type is instantiated includes the following sub-operation(s):
predicting functional requirements;
predicting non-functional requirements;
predicting security requirements;
predicting a number of users to use; and
predicting a workflow sequence.

13. A computer-implemented method (CIM) comprising:
receiving a container instantiation data set that includes the data needed to instantiate at least a first type of container;
receiving a computing environment context data set including information relevant to computing operations currently being performed in a computer environment, with the computer environment context data set including information indicative of at least a first internal factor and a first external factor;
applying an artificial intelligence algorithm to determine a predicted future status of the computing environment based, at least in part, upon the computer environment context data set;
determining, by machine logic and based, at least in part upon the predicted future status, that the computing environment is likely to operate better if a new container of the first type is instantiated; and
automatically instantiating, in the computing environment and based, at least in part, upon the container instantiation data set, a first container of the first type.

14. The CIM of claim 13 wherein the container instantiation data set includes a container image file.

15. The CIM of claim 13 further comprising:
applying the artificial intelligence algorithm predict a codebase from a set of repository(ies);
automatically identifying a set of unit test(s) to be performed;
identifying the appropriate codes and security rules from the set of repository(ies); and/or
creating a first microservice; and
automatically deploying the first microservice.

16. The CIM of claim 13 wherein the application of the artificial intelligence algorithm to determine a predicted future status includes the following sub-operation(s):
using historical learning to identify the pattern of change indicated by the computer environment contextual data set.

17. The CIM of claim 13 wherein the application of the artificial intelligence algorithm to determine a predicted future status includes the following sub-operation(s):
applying the artificial intelligence algorithm to predict system requirements.

18. The CIM of claim 13 wherein the determination that the computing environment is likely to operate better if a new container of the first type is instantiated includes the following sub-operation(s):
predicting functional requirements;
predicting non-functional requirements;
predicting security requirements;
predicting a number of users to use; and
predicting a workflow sequence.
